(19) United States
(12) Patent Application Publication
(10) Pub. No.: US 2015/0170110 A1
(43) Pub. Date: Jun. 18, 2015

(54) METHOD FOR MAINTAINING EQUIPMENT IN LARGE-SCALE TECHNICAL INSTALLATIONS OR PRODUCTION FACILITIES

(71) Applicants: Dirk SCHLUESSEL, Krefeld (DE); Detlef ALBIN, Moers (DE)

(72) Inventors: Dirk SCHLUESSEL, Krefeld (DE); Detlef ALBIN, Moers (DE)

(73) Assignee: Evonik Industries AG, Essen (DE)

(21) Appl. No.: 14/570,792

(22) Filed: Dec. 15, 2014

(30) Foreign Application Priority Data
Dec. 17, 2013 (DE) 102013226186.1

(51) Int. Cl. G06Q 10/00; G06F 11/30

(52) U.S. Cl. CPC G06Q 10/20; G06F 11/3051

(57) ABSTRACT

A computer-implemented maintenance method which simplifies the technical maintenance of a large-scale technical installation or production facility is provided.

### CROSS REFERENCE TO RELATED APPLICATIONS

This application claims priority to German Application No. 102013226186.1, filed Dec. 17, 2013, the contents of which are incorporated herein by reference in its entirety.

### BACKGROUND OF THE INVENTION

The invention relates to a method for maintaining equipment in large-scale technical installations or production facilities and to a computer system together with associated programs for carrying out the method.

Operators of large-scale technical installations or production facilities who operate these installations or production facilities for the purposes of their own business or on behalf of third parties must ensure that equipment used is regularly inspected and maintained and repair measures are initiated if necessary. Depending on the type of equipment, this may be initiated in order to comply with legal specifications or to meet requirements of certification methods which, depending on the type of equipment, may be of varying strictness and the compliance with which may need to be demonstrated to authorities or test organizations using compliant documentation. Standardized, securely archived documentation which can be retrieved at any time is desirable in this context. In addition, the regular inspection, maintenance, testing and repair of the equipment is intended to ensure that the employees can always access functioning equipment which is harmless from occupational safety aspects in order to ensure an undisturbed operating procedure. Regular and timely inspection and maintenance of equipment also make it possible to effectively minimize or exclude any potential risk which may emerge for employees or the environment from safety-relevant equipment. Finally, the regular equipment check is also used to detect imminent failures of equipment in good time and to preventively avoid damage which could be produced for the business by a failure.

A wide variety of equipment is used when operating large-scale technical installations, for example a chemical production plant. Said equipment comprises components of the actual production plant itself (piping, valves, controllers, etc.), aids required for operation (vehicles, lifting platforms, ladders, tools, emergency power units, etc.), building equipment (lifts, lighting, etc.), occupational safety equipment (emergency showers, fire extinguishers, first-aid kits, etc.) and work equipment for the employees (telephones, computers, etc.), where each individual item of equipment forms an equipment unit. The term “equipment” can therefore comprise all equipment units directly or indirectly needed to operate the production plant, including work equipment for the employees.

In large businesses in particular, there are different responsibilities for organizing and carrying out maintenance, inspection, test or repair measures on different equipment units.

There are rarely practices which are standardized throughout the plant. Individual departments or employees usually act according to their own rules. This results in a number of disadvantages.

In the case of official tests or the test for compliance with certification requirements, required documentary evidence is at different locations and on various media, which makes it considerably more difficult to quickly and efficiently access the documentation. The lack of standardized specifications results in different employees handling comparable tasks differently, as a result of which individual operations can be understood by third parties only with difficulty. In addition, there is the risk of individual employees independently handling or interpreting any documentation rules, with the result that the documentation is created incorrectly or in a manner which cannot be understood by third parties. In the worst case scenario, the documentation can no longer be found when it is required.

Work planning which takes into account the capacities of individual employees is possible only with difficulty since no centrally retrievable information relating to measures which are due is available and therefore the measures cannot be distributed to free capacities in a targeted manner. Measures which need to be carried out are therefore unnecessarily delayed or accumulate with an employee who is possibly overloaded.

The lack of consistency when describing or defining required services or services which are carried out also gives rise to a lack of clarity regarding the actual demands imposed on different measures or regarding the services which are actually performed and therefore also the actual status of the equipment.

In addition, measures which are carried out can be only inadequately differentiated to the effect of whether inspection, maintenance or repair measures are involved. This hampers structured recording and accounting of measures and subsequent analytical evaluation.

Finally, when the operator of a large-scale technical installation or a production facility is a service-providing operator for a customer using the installation or production facility, there is the problem of the customer being able to be informed of the maintenance status of the equipment or the completion status of pending measures only with a large amount of effort and of recourse largely having to be made to conventional communication channels during communication and when placing orders. A similar situation also applies to purely in-house procedures.

DE 102 35 794 A1 discloses a system and method for the status-oriented maintenance of at least one decentralized installation, in which status values are recorded and evaluated and maintenance orders are possibly generated. The disadvantage of this system is the necessary recording and transmission of status values and the need for predefined rules for generating maintenance orders. In particular, it should be taken into account that the majority of equipment units in large-scale technical installations do not have communication means which could be used to address a central maintenance management system.

EP 2 463 812 A1 discloses a method and a system in which experience-based warnings or maintenance interval plans are calculated as the result of the recording and analysis of usage and failure data relating to technical systems. This system does not make it possible to monitor and document maintenance measures.

EP 2 444 922 A1 describes the idea of including information relating to technical objects in need of maintenance and repair in a database and assigning images of the respective objects to the data records. This is intended to improve, in particular, the comprehensibility of the database entries irrespective of the group of people using the database and the user-friendliness. This system also does not make it possible to monitor and document maintenance measures.

WO 2007/059318 A2 discloses centralized maintenance management, in particular of commercial vehicle fleets, in which operating data are acquired during operation and are converted into data which can be used to plan maintenance. These data are then used by a central station to plan maintenance work. The system presupposes that equipment which can independently acquire and forward operating data is used.

DE 10 2011 117 803 A1 describes the practice of modifying maintenance procedures on vehicles by evaluating previously created data records which relate diagnostic code data records and work code data records. The method does not enable planning or retrievable documentation of maintenance work for particular vehicles.

EP 1 855 162 A1 describes a service platform for maintaining machines, in which a computer assigned to a particular machine communicates with a central management computer with respect to an existing maintenance or service requirement. This computer-to-computer communication does not enable any planning which can be influenced by third parties and does not enable any understandable documentation of maintenance measures. It guarantees only an automated, purely reactive procedure.

WO 2006/103296 A1 describes a system for planning, documenting and maintaining installations, in which provision is made for the important information relating to all subassemblies of the installations to be combined.

DE 10 2004 056 588 A1 discloses an automated method for creating a maintenance report for a medical device provided with a local computer, in which service data relating to the medical device and maintenance service provider data are transmitted to a central computer system and a maintenance report is automatically generated. Although this method makes it possible to automatically create a maintenance report, it does not make it possible to centrally, preventively plan and document pending maintenance measures.

Against this background, an object of the present invention is to provide a method which simplifies the technical maintenance of a large-scale technical installation or production facility. In this case, the intention is to also maintain equipment which is not able to self-diagnose its status. In addition, the intention is to standardize the organization, handling and documentation of maintenance measures such as tests, inspections and maintenance operations.

Another object of the invention is to provide a technical method which makes it easier for a service provider operating a large-scale technical installation on behalf of the customer and for the customer to communicate and place orders. For external customers in particular, the use of the electronic job requirement is a prerequisite for being able to carry out or reject orders in the double-checking principle.

An electronic information system for scheduling likewise makes it possible for the customer and service provider to make resource planning of personnel and objects optimal.

A further object of the invention is to provide a technical method which enables standardized procedures when maintaining large-scale technical installations or production facilities and ensures easy access to the maintenance documentation.

Another further object of the invention is to ensure structured storage of the results of the maintenance, inspection and test work in a form which is as automated as possible.

In addition, it is an object of the invention to provide a valid system for changing failed maintenance operations, inspections and tests to the maintenance mode and documenting the execution status of the work.

### SUMMARY OF THE INVENTION

These and other objects are provided by the present invention, the first embodiment of which includes a method for maintaining equipment in large-scale technical installations or production facilities, comprising:

a) providing a data processing system in which equipment comprising a multiplicity of individual equipment units is recorded in equipment data records and from which the current maintenance, inspection or test status of the recorded equipment units can be retrieved;

b) generating from the data processing system a digital or non-digital template which relates to a pending maintenance measure and has an equipment identifier which uniquely identifies a particular equipment unit and can be automatically evaluated by the data processing system;

c) conducting the maintenance measure on the equipment unit identified by the generated digital or non-digital template;

d) marking the template with a result code which indicates the result of the maintenance measure conducted and which is automatically evaluated by the data processing system,

e) transmitting the digital template with the result code or an electronic image of the non-digital template with the result code to the data processing system, the data processing system automatically adapting the retrievable current maintenance, inspection or test status according to the equipment identifier and the result code for the affected equipment unit.

In a further embodiment of the present invention the data processing system automatically assigns the digital template or the electronic image of the non-digital template to the equipment data record associated with the equipment unit and stores it in a retrievable manner in a memory of the data processing system.

In another embodiment of the invention, when a negative result is obtained from a conducted maintenance measure on an equipment unit, the data processing system automatically generates a message containing the template provided with the result code and transmits this message to a station responsible for the equipment unit.

The forgoing description is intended to provide a general introduction and summary of the present invention and is not intended to be limiting in its disclosure unless otherwise explicitly stated. The presently preferred embodiments, together with further advantages, will be best understood by reference to the following detailed description.

### DESCRIPTION OF THE PREFERRED EMBODIMENTS

In a first embodiment the present invention provides a method for maintaining equipment in large-scale technical installations or production facilities, comprising:

a) providing a data processing system in which equipment comprising a multiplicity of individual equipment units is recorded in equipment data records and from which the current maintenance, inspection or test status of the recorded equipment units can be retrieved;

b) generating from the data processing system a digital or non-digital template which relates to a pending maintenance measure and has an equipment identifier which uniquely identifies a particular equipment unit and can be automatically evaluated by the data processing system;

c) conducting the maintenance measure on the equipment unit identified by the generated digital or non-digital template;

d) marking the template with a result code which indicates the result of the maintenance measure conducted and which is automatically evaluated by the data processing system,

e) transmitting the digital template with the result code or an electronic image of the non-digital template with the result code to the data processing system, the data processing system automatically adapting the retrievable current maintenance, inspection or test status according to the equipment identifier and the result code for the affected equipment unit.

According to this, provision is first of all made for the equipment comprising a multiplicity of individual equipment units to be recorded in equipment data records in a data processing system and for the current maintenance, inspection or test status of a particular equipment unit to be able to be retrieved. The method therefore assumes that the equipment units, for which the method is intended to be used, are included in a database together with the respectively current maintenance, inspection or test status. The equipment unit and current maintenance, inspection or test status, possibly supplemented with further data, for example the current test instruction, or further detailed test information, form an equipment data record.

In the case of a pending inspection, maintenance or repair measure, a digital or non-digital template relating to the equipment unit to be inspected, maintained, tested or repaired is created via the data processing system. This template may be, in particular, an electronic form or a paper form on which the employee carrying out the measure records the activities carried out. The template has an equipment identifier which uniquely identifies a particular equipment unit and can be automatically evaluated by the data processing system. This may be a numerical and/or letter code, a barcode or the like. In addition to identifying the respective equipment unit, the equipment identifier may also contain further information, for example a date relevant to the measure to be conducted and/or a part which makes it possible to subsequently assign the template to the associated equipment data records.

After the template has been generated, a relevant employee carries out the maintenance, inspection, test or repair measure specified on the template for the relevant specific equipment unit. In this case, the template defines the measure to be conducted according to criteria which have previously been uniformly stipulated for this type of equipment. This ensures that, if a multiplicity of identical equipment units of the same type of equipment are present, the procedure is also standardized when the recurrent, identical measures are carried out by different employees and/or at different times.

After the measure has been completed, the employee marks the template with a result code which characterizes the result of the measure carried out and can be automatically evaluated by the data processing system. For example, after an inspection which did not reveal any defects in the equipment unit inspected, the employee will mark the template with a result code “OK”. Otherwise, if defects to be eliminated have been detected, the template will be marked with a result code which reveals that there are defects, for example “Not OK”.

Further result codes are provided as control elements for customer information in order to be able to automatically store maintenance operations, inspections and tests which have been successfully carried out, but nevertheless to also be able to automatically transmit information which is not relevant to the test but is possibly required to the customer.

This result code must be configured in such a manner that it can be automatically detected and evaluated by the data processing system. For this purpose, the template preferably has a predefined result field to which the result code can be applied.

In the case of a non-digital template, the result code itself may be, in particular, in the form of a preprinted label/checkboxes or the like, which is applied/ticked on the template, in particular the result field, after the measure has been carried out. In addition to marking the template with the result code, the employee conducting the measure acknowledges the performance of the measure and specifies, on the template, any defects identified and possibly follow-up measures deemed to be necessary by him.

After the template has been marked with the result code, the digital template marked with the result code or an electronic image of the non-digital template marked with the result code, including possible external attachments, is transmitted to the data processing system. In order to carry out this process, the employee responsible for the respective measure can transmit the digital template to the data processing system using conventional measures or generates an electronic image of the non-digital template, for example by scanning or photographing it, and then transmits this electronic image to the data processing system. The transmission of the template to the data processing system, that is to say the input of the digital template or the electronic image of the non-digital template to the system or data processing system, and the fact that the template also has a result code which can be automatically evaluated in addition to the equipment identifier which can be automatically evaluated by the data processing system, make it possible for the data processing system to uniquely assign the template to the respective equipment data record of the specifically affected equipment unit using program-related means provided. At the same time, the data processing system automatically adapts the retrievable current maintenance status using the equipment identifier and the result code for the affected equipment unit.

The method described above therefore ensures that the equipment data records are automatically updated in real time after a measure has been carried out and the current maintenance status of the recorded equipment may be retrieved at any time by arbitrary employees or customers with access to the data processing system. The updating of the maintenance status also includes storing the respective maintenance plan for the equipment units inside the system, with the result that, after the temporal expiry of provided maintenance intervals, a signal for conducting the required maintenance measure is initiated. This is accomplished easily by generating the template which identifies the measure.

One advantageous aspect of the method also provides for the data processing system to automatically assign the digital template or the image of the non-digital template, including possible electronic images of externally generated attachments, to the equipment data record associated with the equipment unit and to store it in a retrievable manner in a memory of the data processing system. This central recording of the templates which have been filled in, that is to say, in particular, the inspection, maintenance, test and repair documentation, makes it possible to directly access the stored documentation in the event of a test. There is no need for complicated “collection” of the documentation. Furthermore, in the cases of repeated measures or measures which cause one another or are based on one another, a documentation history is produced and may be used to easily demonstrate the proper performance of inspection, maintenance, test or repair measures over many measures and over a long period of time for the operator and to understand it.

In order to preclude the situation in which the templates which have been filled in may be subsequently changed, provision may also be made for the data processing system to store the digital template or the electronic image of the non-digital template, including possible external attachments, in a change-proof manner. On the one hand, this prevents any attempts at manipulation. On the other hand, legal specifications are also complied with in this manner.

The equipment identifier generated for a template by the data processing system during its creation may preferably be at least part of the file name which is allocated by the data processing system using program-related means provided for this purpose after the measure has been carried out and after the digital template or the electronic image of the non-digital template has been subsequently transmitted to the data processing system and which is used by the data processing system to assign the template which has been filled in and transmitted, as an inspection, maintenance, test or repair log, to the associated equipment data record.

In order to simplify the method further, provision may be made, after a measure and after the template provided with the result code has been transmitted, for the data processing system to use program-related means to automatically create a message which may be used to inform the station responsible for the equipment, for instance the relevant employee or customer, on whose behalf the measure was carried out, or other interested persons of the result of the measure. In particular, a notification takes place only when the maintenance measure is negative, that is to say the equipment has failed. The responsible station is therefore not overloaded with information which does not require a need for action.

The message created may either be automatically transmitted by the data processing system or else may only be provided for transmission in the system, with the result that the message may possibly also be supplemented by a relevant employee, for example with a cost proposal if a need to repair the relevant equipment unit has been determined during the measure, or with an invoice if billable services have been provided during the measure.

If a repair proposal and/or cost proposal is/are transmitted to the responsible station with the notification relating to a failed maintenance measure, provision may be made in the system for the approval of the repair proposal and/or cost proposal by the relevant station to be accepted and for the measures listed in the repair proposal and/or cost proposal to then be initiated; more precisely for the repair order to be initiated.

A particular advantage of the templates used according to the invention is that the templates may also be used to record the maintenance statuses of those equipment units which are not capable of self-diagnosis. On the one hand, there is “intelligent” equipment having its own controller which itself monitors the maintenance status of the equipment. More recent industrial trucks, for example, thus have operating hours counters which independently output a maintenance request after a preset number of operating hours has been reached, comparable to the “service lamp” in an automobile. However, the far greater number of equipment units used nowadays is “dumb” and does not have any possibility for self-diagnosis, for instance a ladder. The method is therefore preferably used to maintain equipment units which at least partially are not able to self-diagnose their current maintenance, inspection and test status. The system may nevertheless be used in those establishments which comprise both intelligent and dumb equipment units.

In one preferred embodiment, the method may comprise a check analysis during which an overview of the maintenance measures which have been conducted and open maintenance measures are displayed from the data processing system. In this manner, the person responsible for maintaining the equipment can gain an overview of the “to-dos” which have been carried out and the “to-dos” which are still open, which facilitates work organization for him.

The open maintenance measures may also be displayed in calendar form, with the result that the station responsible for the equipment has an overview of when maintenance measures are carried out on which equipment, with the result that any downtimes of the equipment may be planned.

In another aspect, the method may comprise a check analysis during which the current maintenance, inspection and test status of the maintained equipment units is displayed. This analysis makes it possible for the person responsible for operations to gain an overview of the current maintenance status of his entire installation. In this manner, he may better estimate the risk emanating from his installation.

The current maintenance, inspection and test status of the maintained equipment units may be displayed using a colour pattern, the colours of which are assigned to the result codes of the maintenance measures which have been carried out or the pending maintenance measures. Foe example, an equipment unit whose last maintenance measure was concluded with “OK” may be displayed in green. An equipment unit for which a maintenance measure is already pending according to the maintenance plan stored in the system but has not yet been conducted may be marked in yellow. A maintenance measure which has not yet been initiated or is negative may be marked in red. In this manner, the installation manager is provided with an easily accessible traffic-light display of the maintenance status of the equipment units for which he is responsible. In addition, equipment which was not found by the maintenance personnel at the intended time (for instance a lost ladder) could be marked separately, for example in black.

The current maintenance, inspection and test status of the maintained equipment units may be displayed in a grouped manner, in particular according to their affiliation to particular equipment. This simplifies the overview. In addition, a plant hierarchy may accordingly be displayed, with the result that the installation manager sees only the status of his own equipment, whereas the site manager is respectively presented only with the overall status of the individual installations on his site without being overloaded with details from the installations.

The data processing system may include an interface which makes it possible for the station responsible for the maintained equipment to delete equipment units which have already been recorded from the data processing system or to newly record equipment units which have not been previously recorded. It is therefore possible for the responsible station (customer, relevant employee) to independently incorporate newly acquired equipment in the maintenance system and to remove decommissioned equipment from the maintenance system. The interface should assist the user when including new equipment by providing the user with templates of comparable equipment.

In a further embodiment, the present invention provides for the data processing system to generate templates containing additional information for the maintenance personnel or the station responsible for the equipment, for example a performance description of the maintenance measure, with the result that the responsible station can decide whether or not the measure needs to be carried out, or the definition of test boundary conditions and/or test details required by the equipment, for example a particular qualification of the test personnel.

The data processing system may include the capability to grant different access rights to the equipment data records to different groups of people on a basis of the “need-to-know principle”. This applies all the more if a service provider entrusted with the maintenance of equipment from different installation operators carries out the maintenance method. It may therefore be possible to prevent one customer from having access to the maintenance data for another customer who is having his installation maintained by the same service provider.

The maintenance personnel will generally not only carry out a single maintenance measure on a single equipment unit but rather will carry out all measures pending for the relevant equipment or all measures of a particular category for a group of equipment, for instance the electrical test of all pumps in an installation, all tests on equipment/measuring points of an apparatus, or the checking of all hoists in a hall. Therefore, in one aspect the present invention provides for a plurality of templates relating to a group of pending maintenance measures to be generated, and, after the maintenance measures included in the group have been conducted, the individual result codes of the maintenance measures may be transmitted to the data processing system in collected form. In this manner, the electrician or the crane tester may be provided with a work package tailored to his area of work in the form of a bundle of templates, which is read in collected form after returning from his rounds. This helps when bundling measures around or on an object/object type.

The maintenance method may at least partially be conducted in a computer-implemented manner.

Therefore, the invention is likewise considered to include a computer system for carrying out the maintenance method together with an associated computer program or computer program product comprising program code which instruct a data processing system to carry out the method described above during their execution on the data processing system.

Therefore, the invention also relates to a computer system for maintaining equipment in large-scale technical installations or production facilities, having a data processing system in which equipment comprising a multiplicity of individual equipment units is recorded in equipment data records and from which the current maintenance, inspection or test status of the recorded equipment units may be retrieved, having an output device for generating digital and/or non-digital templates, including possible external attachments, having a recording device for reading in digital templates marked with result codes and/or electronic images of non-digital templates marked with result codes, and having transmitting capability for forwarding the result codes read in via the recording device to the data processing system, the computer system containing programming to conduct the method according to the invention.

The invention likewise relates to the use of such a computer system for carrying out the method according to the invention.

The invention also relates to a computer program having instructions which are set up to carry out a method according to the invention.

Such a computer program may be embodied in a computer program product having a computer-readable medium with computer program code means. After the computer program has been loaded from the medium into a computer, the computer is set up to carry out a method according to the invention by means of the program.

The computer program may also be implemented in a computer program product having the computer program on an electronic signal (download version). After the computer program has been loaded from the electronic signal into a computer, the computer is set up to carry out a method according to the invention by means of the program.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention.

Thus, this invention is not intended to be limited to the embodiments shown, but is to be accorded the widest scope consistent with the principles and features disclosed herein. In this regard, certain embodiments within the invention may not show every benefit of the invention, considered broadly.

1. A method for maintaining equipment in large-scale technical installations or production facilities, comprising:
a) providing a data processing system in which equipment comprising a multiplicity of individual equipment units is recorded in equipment data records and from which the current maintenance, inspection or test status of the recorded equipment units can be retrieved;
b) generating from the data processing system a digital or non-digital template which relates to a pending maintenance measure and has an equipment identifier which uniquely identifies a particular equipment unit and can be automatically evaluated by the data processing system;
c) conducting the maintenance measure on the equipment unit identified by the generated digital or non-digital template;
d) marking the template with a result code which indicates the result of the maintenance measure conducted and which is automatically evaluated by the data processing system,
e) transmitting the digital template with the result code or an electronic image of the non-digital template with the result code to the data processing system, the data processing system automatically adapting the retrievable current maintenance, inspection or test status according to the equipment identifier and the result code for the affected equipment unit.

2. The method according to claim 1, wherein the data processing system automatically assigns the digital template or the electronic image of the non-digital template to the equipment data record associated with the equipment unit and stores it in a retrievable manner in a memory of the data processing system.

3. The method according to claim 2, wherein the data processing system stores the digital template or the electronic image of the non-digital template, including an electronic image of a non-digital attachment of external origin, in the memory of the data processing system.

4. The method according to claim 2, wherein the data processing system stores the digital template or the image of the non-digital template in a change-proof manner.

5. The method according to claim 1, wherein the data processing system automatically allocates a file name for the template to be stored in the memory, and at least part of the file name created includes the equipment identifier.

6. The method according to claim 1, wherein when a negative result is obtained from a conducted maintenance measure on an equipment unit, the data processing system automatically generates a message containing the template provided with the result code and transmits this message to a station responsible for the equipment unit.

7. The method according to claim 1, wherein when a negative result is obtained from a conducted maintenance measure on an equipment unit, the data processing system generates a message containing a repair proposal and/or cost proposal, transmits this message to a station responsible for the equipment unit and, after the repair proposal or cost proposal has been approved by the responsible station, the data processing system initiates the measures needed to repair the equipment according to the repair proposal and/or cost proposal.

8. The method according to claim 1, wherein at least some of the maintained equipment units are not able to self-diagnose their current maintenance, inspection and test status.

9. The method according to claim 1, wherein the data processing system independently generates a calendar overview of the pending maintenance measures.

10. The method according to claim 1, wherein the data processing system comprises an interface for recording equipment units which have previously not been recorded and/or for deleting equipment units which have been recorded.

11. The method according to claim 1, wherein the digital or non-digital template relating to the pending maintenance measure is generated with the inclusion of a performance description of the maintenance measure and/or the definition of test boundary conditions and/or test details of the maintenance measure.

12. The method according to claim 1, further comprising a check analysis during which an overview of the maintenance measures which have been conducted and open maintenance measures is displayed from the data processing system.

13. The method according to claim 1, further comprising a check analysis during which the current maintenance, inspection and test status of the maintained equipment units is displayed.

14. The method according to claim 13, wherein the current maintenance, inspection and test status of the maintained equipment units is displayed using a colour pattern, the colours of which are assigned to the result codes of the maintenance measures which have been conducted or the pending maintenance measures.

15. The method according to claim 13, wherein, the current maintenance, inspection and test status of the maintained equipment units is displayed in a grouped manner according to affiliation to a particular equipment.

16. The method according to claim 1, wherein the data processing system is structured in such a manner that it grants different access rights to the equipment data records to different groups of people.

17. The method according to claim 1, wherein a plurality of templates relating to a group of pending maintenance measures are generated, and after the maintenance measures included in the group have been conducted, the individual result codes of the maintenance measures are transmitted to the data processing system in a collected form.

18. A computer system for maintaining equipment in large-scale technical installations or production facilities according to the method of claim 1, comprising:
a data processing system in which equipment comprising a multiplicity of individual equipment units is recorded in equipment data records and from which the current maintenance, inspection or test status of the recorded equipment units can be retrieved;
an output device for generating digital and/or non-digital templates;
a recording device for reading in digital templates marked with result codes and/or electronic images of non-digital templates marked with result codes; and
transmitting capability for forwarding the result codes read in via the recording device to the data processing system.

19. A computer programmed with instructions to conduct the method according to claim 1.
